(19) United States
(12) Patent Application Publication
(10) Pub. No.: US 2003/0063136 A1
(43) Pub. Date: Apr. 3, 2003

(54) Method and software for hybrid electronic note taking

(76) Inventor: Jack Ivan J'maev, Chino, CA (US)

Correspondence Address: Jack J'maev, SUITE 110, 11800 CENTRAL AVE., CHINO, CA, 91710, US

(21) Appl. No.: 10/261,725

(22) Filed: Oct. 1, 2002

Related U.S. Application Data
(60) Provisional application No. 60/326,609, filed on Oct. 2, 2001.

(51) Int. Cl. G09G 5/00

(52) U.S. Cl. 345/864

(57) ABSTRACT

Method and software for capturing image of notes imparted onto physical medium. Extracted textual information from the image is affiliated with therewith. Textual information may be searched enabling later retrieval of the textual information or its affiliated image. Conduit supports storage of information in a personal digital assistant.

### RELATED APPLICATIONS

This present application is related to a provisional application serial No. 60/326,609 filed on Oct. 2, 2001, entitled “METHOD AND SOFTWARE FOR HYBRID ELECTRONIC NOTE TAKING”, by J'maev, currently pending, for which the priority date for this application is hereby claimed.

### BACKGROUND OF THE INVENTION

1. Technical Field

This invention pertains to the field of electronic note taking.

2. Description of the Prior Art

Modern electronic note taking has taken many forms. Most of the techniques used to take notes electronically are based on the use of a personal computer, and in some embodiments an electronic personal digital assistant (PDA) is employed.

Using a personal computer (PC) to take notes electronically has proven to be a difficult and frustrating experience because of the size and weight of the computer. Even small notebook or laptop computers are bulky. Most people simply find it awkward or inconvenient to set up these devices; especially where note-taking is limited to a few sheets of paper.

Taking notes electronically using a PDA can be equally as frustrating, but for other reasons. Most PDAs used today do not provide an efficient means for accepting textual input. These PDA devices typically recognize some form of a stroked character set, i.e. “graffiti”. Using the stroked characters is not an effective text capture means, especially in a dynamic note-taking encounter.

The PDA has demonstrated itself to be a reasonable means for taking sparse textual notes electronically, and new software for these devices has allowed a user to capture graphic images as well. Much to everyone's chagrin, these software programs capture graphic images even when text is entered. Because of this, these software programs do not allow users to search through graphic notes according to any textual information that may be included in the graphical image.

Of course, the major limitation of how to enter text and graphics collectively can be overcome by using separate windows on a PDA screen. One window could be used to accept a graphic image using the PDA stylus as a drawing instrument while an alternate window could be used to enter text. In this type of scenario, the active window could be designated by merely detecting which window the stylus is directed to. This solution is still not optimum. Even though entering graphics would be simple enough, textual data would still need to be entered using the now notoriously inconvenient stroked characters that PDAs recognize.

One additional disadvantage to this split-window solutions is that the correlation of textual information to any given graphic image can not be captured.

Another solution to this note-taking problem is to present a single graphical input window to the user and accept mixed modes of graphic and text entry. But solutions following this paradigm are fraught with lexical interface problems beyond the scope of this disclosure. One additional, and exceptionally significant problem that arises with electronic note-taking using a PDA is the physical screen size. Most PDA screens provide no more than a 2.5″ square active area. This is just not enough for serious note taking.

Given all of these pitfalls, electronic note taking has fallen long short of the level of public acceptance that was originally envisioned. In fact, electronic note taking is so cumbersome, that many people have reverted to traditional pen-and-paper note taking.

Using a sheet of paper to take notes has some significant advantages over electronic note taking. There is, of course, the “feel” of paper. It is familiar and comfortable. Then, there is the nice large surface area; i.e. 8.5×11 inches in the United States. These factors may make pen-and-paper note taking attractive, but it does little for the advancement of the art. Pen-and-paper offers no means to search electronically through the textual content of each sheet of paper and the sheets themselves are cumbersome to manage. Over time, a user can develop a stack of paper that can no longer be effectively managed. And most importantly, no one is really willing to carry around a voluminous notebook when a compact PDA should suffice.

What is needed is a method for using traditional pen-and-paper for taking notes that also enables the user to take advantage of modern technology. One such mechanism has recently been developed. This well known technique used a bulky and very costly graphical imaging device that captured text and graphics written down on a sheet of paper. This method had, in many regards, overcome the limitations of the art known prior to its introduction. It allowed simple capture of graphic images from a large sheet of paper. This technology fell short in two vital regards; first, it failed to provide a means for organizing the images that were captured by the graphics tablet, and second, the graphics tablet could only capture graphics. Any text entered was captured graphically (usually in bit-map form). Hence, the textual information could not be extracted nor could sheets of paper be searched according to their textual content.

### SUMMARY

The present intention comprises a method for taking electronic notes comprising steps for capturing image of a medium wear on notes are recorded by a user. Textual information may be extracted from the image. According to one example method of the present intention, the textual information extracted from the image is affiliated with the image. The textual information may then be stored. Generally, textual information may be extracted from an image using a number of different optical recognition engines, including but not limited to printed character recognition, handwritten-character recognition and hand-printed character recognition.

According to one example variation of the present method, the image may contain a topic descriptor. Hence, the method may provide for extracting the topic descriptor from the image and then storing the topic descriptor. In one alternative variation of this method, the image may contain a date descriptor. Accordingly, this example method provides for storing the date descriptor once it is extracted from the image.

In one illustrative method of the present intention, textual information captured from an image may be conveyed to a personal digital assistant. And yet another variation of this method, the image affiliated with the textual information may also be conveyed to a personal digital assistant.

In order to enable retrieval of information once it is captured by the method of the present intention, additional process steps may be provided for receiving search criteria from a user. Textual information may then be found according to the search criteria and presented to the user. And yet another variation of this illustrative method, a graphic image affiliated with textual information found according to the search criteria may also be presented to the user. Searching may be conducted according to a topic descriptor, a date descriptor or any arbitrary phrase that may be received from the user.

The method of the present intention may be embodied in a computer software program. According to one example of embodied, a software program may comprise an acquisition module that is capable of accepting an image from a digitizing source. Further comprising the software program may be an extraction module that is capable of extracting textual information from an image excepted by the acquisition module. The extraction module may then store the extracting textual information and affiliate the textual information with the image from which it was extracted.

One alternative embodiment of a software program may comprise an optical character recognition unit. The optical character recognition unit may generate character codes that corresponds to printed characters discovered in an image. And yet another alternative embodiment, a software program may comprise a handwritten character recognition module. The handwritten character recognition module typically generate character codes corresponding to hand written characters that it may discover in an image. To get a third alternative embodiment of the present intention, the software program may comprise it printed-text character recognition module. This printed-text character recognition module may generate character codes corresponding to hand-printed characters that may be discovered in an image.

In order to improve the effectiveness of any character recognition that may be conducted by the software program, one illustrative embodiment of the present invention may further comprise a lexical analyzer module. The lexical analyzer module may be used in conjunction with a plurality of character recognition modules. This example of embodiment, various character recognition modules comprising the software program may be separately executed in order to generate character codes and character positions corresponding to characters that may be separately perceived in an image by each character recognition module. The lexical analyzer module may then assemble words or phrases according to the character codes and their positions together with an enumeration of known words or phrases.

One example of embodiment of a software program according to the present invention may further comprise a search module. The search module may receive search criteria from a user and subsequently find textual information according to the search criteria. If corresponding textual information is in fact found, it may be presented to the user. Also, any image affiliated with textual information that may correspond to search criteria may also be presented to the user. The search module may accept a topic descriptor, a date descriptor or any arbitrary phrase that may be provided by the user.

Further enhancing the utility of the present invention, one illustrative embodiment provides that the computer software program may further comprise a personal digital assistant module. The personal digital assistant module typically retrieves textual information previously extracted from an image and may direct that to a synchronization module. In an alternative embodiment of the present invention, the personal digital assistant module may retrieve an image affiliated with actual information and direct this to the synchronization module. When the synchronization module is executed, textual and/or image information may be conveyed to a personal digital assistant.

### BRIEF DESCRIPTION OF THE DRAWINGS

The foregoing aspects are better understood from the following detailed description of one embodiment of the invention with reference to the drawings, in which:

FIG. 1 is a flow diagram that depicts a hybrid electronic note-taking process according to one example embodiment of the present invention;

FIG. 2 is a flow diagram that depicts a process that allows a user to retrieve images of notepaper stored in a notes database as implemented in one example embodiment of the present invention;

FIG. 3 is a pictorial representation of one example embodiment of a hybrid electronic note taking system according to the present invention;

FIG. 4 is a pictorial representation of a notes database used in one example embodiment of the present invention;

FIG. 5 is a flow diagram that depicts the modules that comprise a user software program according to one example embodiment of the present invention and data flow between those modules;

FIG. 6 is a pictorial representation of a graphical user interface used for verification of textual information extracted from a graphic image;

FIG. 7 is a continuation of the flow diagram presented in FIG. 5 and depicts other modules in the user program according to one example embodiment of the present invention;

FIG. 8 is a pictorial representation of a search GUI according to one example embodiments of the present invention; and

FIG. 9 is a pictorial representation of a text display GUI according to one example embodiment of the present invention.

### DETAILED DESCRIPTION OF THE INVENTION

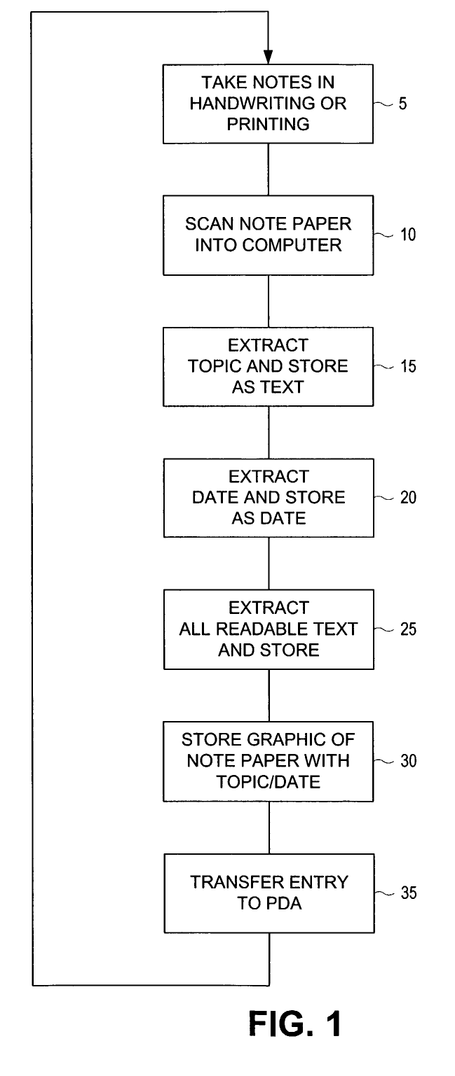

FIG. 1 is a flow diagram that depicts a hybrid electronic note-taking process according to one example embodiment of the present invention. In this example embodiment, the first step in the process for taking notes comprises a step for taking notes on a sheet paper (step 5). Notes can be taken in the user's own handwriting or printing. Likewise, pre-printed information can be just as equally accepted. In some situations, a user can even use a pre-printed form that has certain fields completed in the users own hand. Notes can be taken on any size sheet paper and notes can span multiple sheets of paper. Also, the paper need not necessarily be blank. The paper may have lines, a graduated pattern or the paper may even have special markings to facilitate the note taking process.

Whenever it is convenient for the user, each sheet of notepaper is scanned into a computer (step 10). Scanning the note sheets into the computer can be accomplished using a flatbed scanner, or any other optical image capture device. Generally, the images captured by the scanner are stored in the computer in a graphics image format. Once the graphic image of each sheet of notepaper is captured, the process provides for the extraction of a note topic and storage of that topic (step 15). It should also be noted that extraction of a topic for each sheet of notepaper could be considered an optional step.

Extraction of the note topic, or any other readable text is accomplished by subjecting the graphic image to a optical character recognition module. The types of optical character recognition modules that are utilized in one example embodiment include a traditional optical character recognition (OCR) module, a handwriting recognition module and a hand-printed text recognition module. All of these optical character recognition modules are capable of extracting text into a coded form from graphic images that they scan. Normally, the text returned by these modules is in an ASCII code, but the scope of the present invention is not to be limited to any one character-coding scheme.

The OCR recognition module is capable of extracting text into a coded form from electronic images of text printed in a regular font. This type of text may be found in books or may be printed onto paper by a computer printer. The handwriting recognition module is capable of discerning longhand (cursive) characters written by a human being and captured in an electronic image. The hand-printed-text recognition module is capable of recognizing hand-printed text.

In one example embodiment of the present invention, the method provides that a date value be extracted from the graphic image and stored (step 20). Generally, extraction of the date is an optional step.

The process of the present invention provides that any readable text that can be recognized by any of the optical character recognition modules, i.e. the OCR module, the handwriting recognition module, or the printed-text recognition module, is to be extracted from the graphic image and stored (step 25).

One key feature of the present invention is the extraction of any readable and recognizable text from the graphic image. This is why extraction of any particularly significant information, such as a topic heading or date, can be considered as an optional step in the process. Hence, in one example embodiment of the present invention, the step of extracting a topic (step 15) is optional.

After all of the recognizable text is extracted from the graphic image, the graphic image is itself stored (step 30). The graphics image is stored together with the extracted textual data that can be used as an index to retrieve the image.

Retrieval of a graphic image can be based on any combination of the extracted topic, the extracted date, or the other extracted readable text. Each image together with the text extracted therefrom forms a record stored in a notes database. In an optional step not shown in the flow diagram, the graphics image is presented to the user together with the extracted topic and/or the extracted date and/or the other extracted readable text. The user is allowed to proof the optical character recognition process before the record is stored in the note database.

In yet another example embodiment of the present invention, the process may provide for another optional step. In this optional step, the database containing the graphics image and the associated extracted text is compressed and transferred to a personal digital assistant (PDA). Generally, these files will be compressed in order to conserve memory required to store this information in the PDA. Other software operating in the PDA de-compresses the information before presenting it to the user.

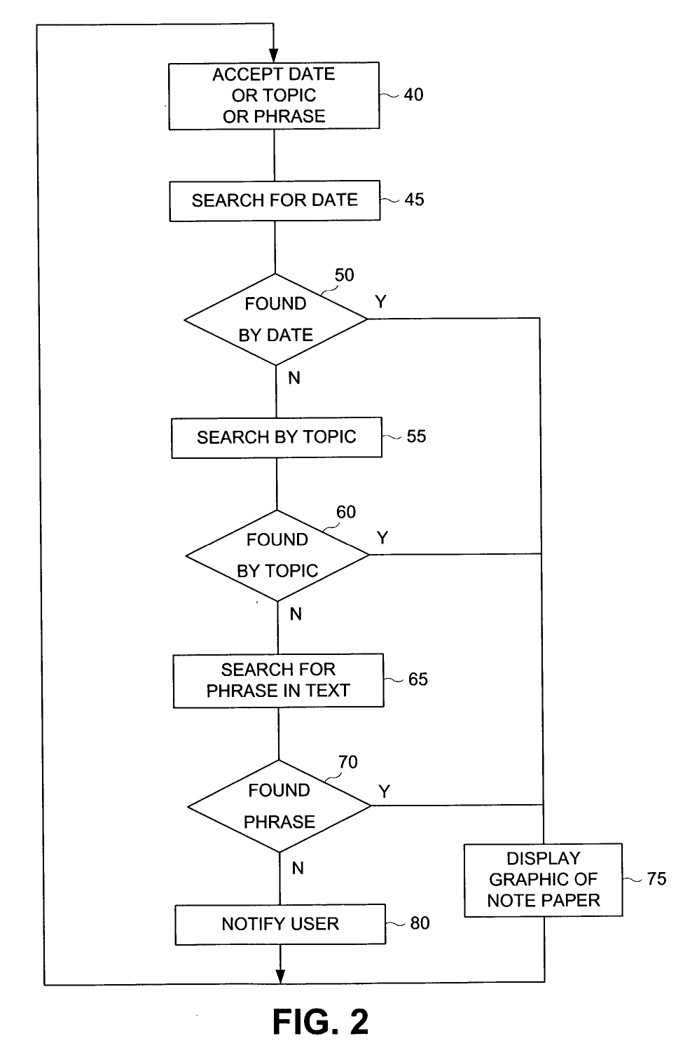

FIG. 2 is a flow diagram that depicts a process that allows a user to retrieve images of notepaper stored in a notes database as implemented in one example embodiment of the present invention. In this example embodiment, the user is prompted to enter the date, or a topic, or some other phrase that could be used as search criteria in selecting a graphic image. Where a date is entered, the method provides that all of the records stored in the database are to be examined by date (step 45). If the date index of a given record is found to match the user supplied search date (step 15), the graphics image for the associated sheet of notes is retrieved from the database and present to the user (step 75). If the date search fails, or if the user entered a topic as the search criteria, the method provides that the records be searched for a topic match (step 55). If the a match is discovered for the topic (step 60), the method provides that the graphic image associated with the selected record be displayed to the user (step 75). If the topic search fails, and/or if the user specified a particular phrase as the search criteria, all of the records in the database are searched according to the phrase provided by the user (step 65). If the phrase submitted by the user for searching is found in the database (step 70), the graphic image associated with the selected record is presented to the user (step 75). In the event that neither the topic, nor the date, nor the phrase submitted by the user returns a positive match, the user is notified that a graphics image corresponding to the submitted search could not be found (step 80). This process is then repeated until the user's queries are satisfied. In some alternative embodiments, the actual search is conducted using partial matching routings and fuzzy selection criteria systems that are well known in the art of database searching.

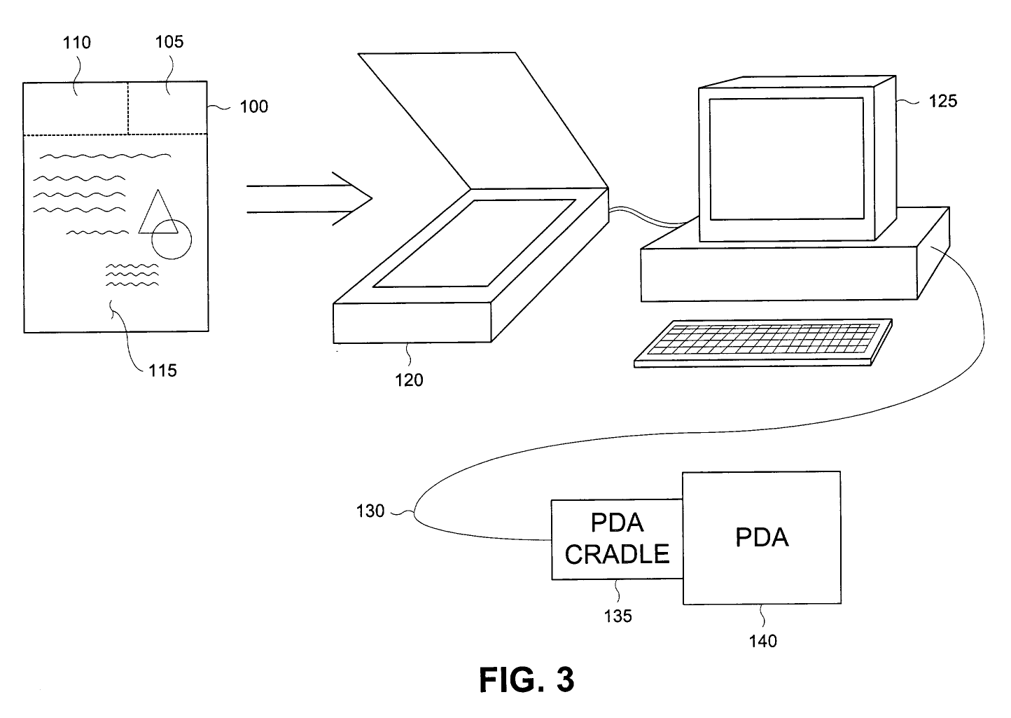

FIG. 3 is a pictorial representation of one example embodiment of a hybrid electronic note taking system according to the present invention. Although not specifically part of the system, per se, a sheet of paper 100 is used by an individual user to take notes. Notes recorded on this sheet of paper 100 may comprise text penned either in longhand or printed by the user. The notes recorded on the sheet of paper may further comprise graphics. Whatever the nature of the notes recorded on the sheet of paper 100, the markings on the sheet of paper 100 are scanned into a computer 125 using a flatbed scanner 120. The computer 125 receives electronic information from the flatbed scanner 120 that depicts the markings made by the user on the sheet of paper 100. A software program executing on the computer 125 orchestrates the capture of images from the flatbed scanner 120 into computer readable media.

In one example embodiment of the present invention, the sheet of paper 100 may further comprise special regions that may or may not be visibly delineated on the paper. These special regions may be included on a sheet of paper to facilitate parsing the content of the notes recorded thereon and aid in the extraction of significant information. Examples of such special regions may include a topic region and a date region. Note that the number and type of regions may be varied to suit specific applications of the invention.

In one example embodiment, a date region 105 is provided at the upper right corner of the sheet of paper 100. Any text written in the date region is evaluated by the text extraction modules and interpreted as a date value. In yet another example embodiment of the present invention, the sheet of paper 100 may comprise a topic region 110. During processing, any readable text that can be extracted by character recognition modules that is located within the topic region 110 will be interpreted as the topic to be affiliated with the notes recorded on the sheet of paper 100. In any given embodiment of the present invention where the sheet of paper 100 is partitioned into regions, the sheet of paper may also further comprise a notes region 115. The text that can be extracted from the notes region 115 will be stored as other readable text in the notes database.

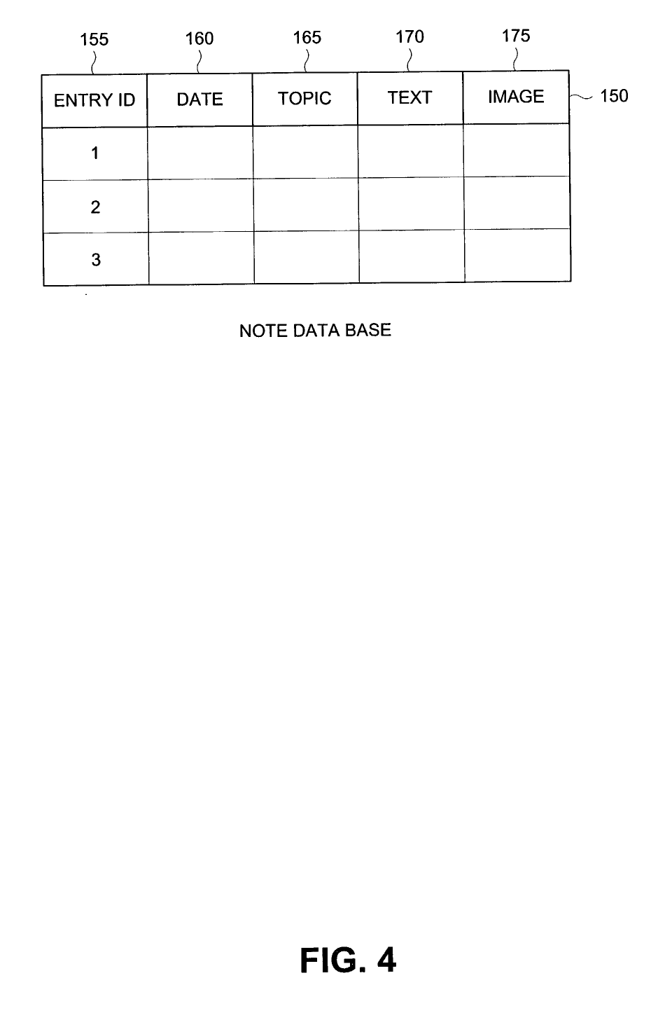

FIG. 4 is a pictorial representation of a notes database used in one example embodiment of the present invention. The notes database 150 comprises a table of records, wherein each record comprises a particular field. According to one embodiment of the present invention, the notes database 150 comprises an entry identification field 155. The entry identification field 155 is used for general keying of the database in the event that other fields in the database have non-unique entries.

Depending on any particular implementation of the present invention, the notes database 150 may comprise a date field 160. The notes database may further comprise a topic field 165 and the notes database may further comprise a text field 170. Most implementations of the present invention will, but not necessarily comprise an image field 175 in the notes database 150.

In an example embodiment of the present invention that comprises a date field 160 in the notes database 150, the date field 160 is used to store a representation of a date that may be extracted from a graphic image acquired by the flatbed scanner 120.

In an example embodiment of the present invention that comprises a topic field 165 in the notes database 150, the topic field 165 is used to store any topic heading extracted from a graphic image acquired by the flatbed scanner 120.

In an example embodiment of the present invention that comprises a text field 170 in the notes database 150, the text field 170 is used to store any other readable text extracted from a graphic image acquired by the flatbed scanner 120.

In one illustrative embodiment of the present invention that comprises an image field 175 in the notes database 150, the image field 175 is used to store a digital representation of the graphic image captured by the flatbed scanner 120.

Again, it should be noted that the image of the sheet of note paper 100 can be digitized in any one of a number of known manners, including, but not limited to the use of digital cameras, drum scanners and flat bed scanners.

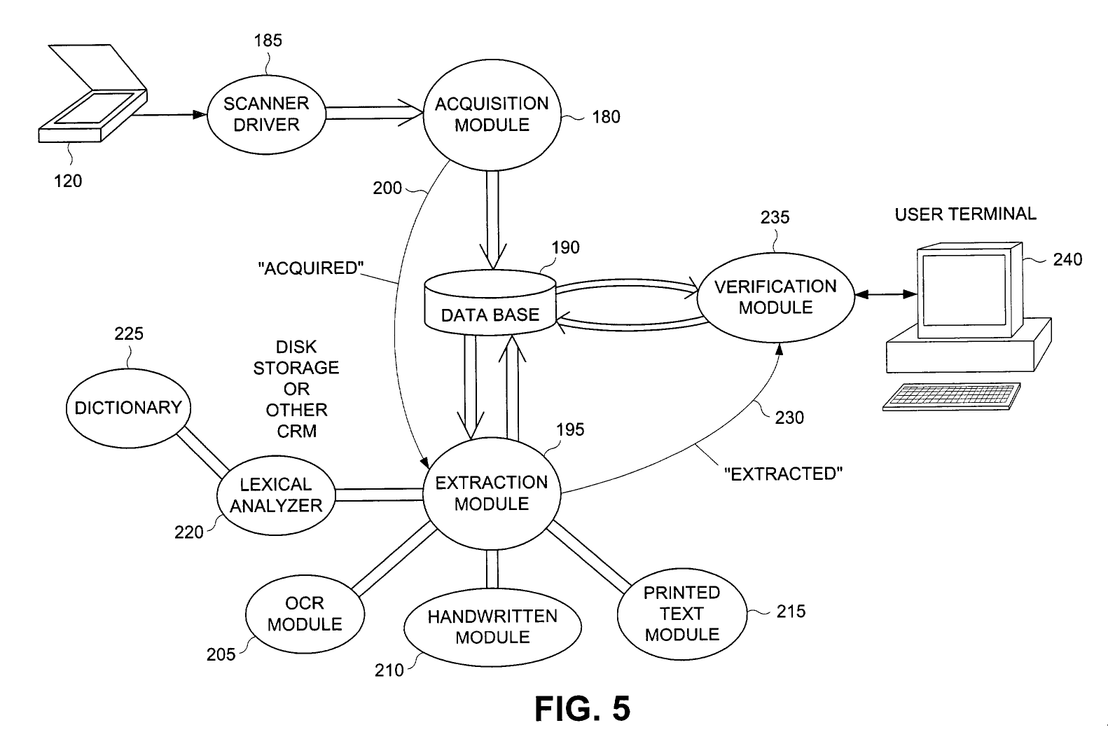

FIG. 5 is a flow diagram that depicts the modules that comprise a user software program according to one example embodiment of the present invention and the data flow between those modules. The modules depicted in this FIG. collectively form a software program that executes on the personal computer 125. This program is called the user program.

The first significant module of the user program is the acquisition module 180. The acquisition module 180 is invoked whenever the user needs to scan one or more sheets of notepaper into the computer 125. The acquisition module 180 interfaces with a scanner driver 185. In most embodiments, the manufacturer of the flatbed scanner 120 provides the scanner driver 185. The scanner driver 185 comprises software that communicates with the flatbed scanner 120 and is cognizant of unique hardware attributes of a particular scanner. The scanner driver 185 will cause the flatbed scanner 120 to scan one or more sheets of paper that are presented by the user.

The scanner driver 185 receives a digital representation of the images drawn on each sheet of paper fed into the flatbed scanner 120. These electronic image representations are returned to the acquisition module 180. The actual format of the digital representation of each electronic image captured by the flatbed scanner 120 is a little consequence. In fact, the electronic imaging industry supports several standard image file formats inter alia TIFF and GIF. It should be noted that the scope of the present invention should not be limited by type of image file used to store images captured by the flatbed scanner 120. Also, the scope of the present invention should not be limited to the use of non-compressed or compressed image file formats.

The acquisition module 180 creates a new record in the notes database 150 for each newly acquired image. The notes database is itself stored on a computer readable media 190. In most embodiments, the computer readable media 190 will be a hard disk integral to the personal computer that is executing the user program. However, the computer readable media 190 may be system memory or it may be a remote disk. Again, the scope of the present invention is not to be limited by the physical storage media used to store the images acquired by the flatbed scanner 120.

Once an image has been stored in the notes database 150, the acquisition module 180 sends a signal, i.e. the “acquired signal” 200, to a module called the extraction module 195. The extraction module 195 uses the image stored in the notes database 150 and invokes any of three optical character recognition modules. These include an optical-character-recognition (OCR) module 205, a handwriting recognition module 210, and a hand-printed-text recognition module 215. Each of these recognition systems examines the image retrieved from the notes database 150 by the extraction module 195. In this example embodiment, the preferred note taking language is English. Hence, images stored in the notes database 150 are examined from the top-left corner down through the bottom-right hand corner; scanning the image from left to right and top to bottom. Each recognition module returns a series of character codes back to the extraction module together with a location indicating where each character was discovered in the image.

In some cases, the text found in a graphic image will be printed text. The OCR module 205 best recognizes printed text of this nature. And in other instances, the text in the graphic image will consist of hand written characters. This type of textual information is best recognized by the handwriting recognition module 210. And yet in other cases, the text found in the graphics image will consist of hand printed text that is best recognized using a hand-printed-text recognition module 215. All of these recognition means are well known in the art.

Because text imparted by a user on a sheet of paper can consist of any combination of printed and/or hand written characters, the extraction module 195 receives character information together with the location where each character was found on the sheet of paper from each of the three recognition modules employed in the extraction process. The extraction module 195 then attempts to construct words and phrases from the sequence of characters received from the three recognition modules. Where the user has co-mingled hand written or printed text together on the same sheet of paper, the extraction module 195 organizes the separate character streams received from the three recognition modules according to the location that they were found on each sheet of paper. In any given embodiment of the present invention, not all recognition modules will be supported and in any given implementation, various combinations of recognition modules may comprise the invention.

To enhance this reconstruction process, the extraction module 195 employs a lexical analyzer 220. The lexical analyzer uses a dictionary 225 to help identify words that may be built from character sequences received by the extraction module 195 from the three recognition modules. The extraction module 195 receives series of words from the lexical analyzer 220. In some embodiments, the lexical analyzer accepts phrase guidelines that enable the reconstruction of phrases that a particular user is likely to scribble down on a sheet of notepaper.

The extraction module 195 is also responsible for cropping each graphic image stored in the notes database 150 according to specialized regions on the sheet of paper 100. These specialize regions may comprise a date field 105, a topic field 110, and a notes field 115. In some embodiments, the extraction module 195 uses visible markings on the sheet of notepaper 100 to delineate various regions of significance. In other embodiments, the lexical analyzer extracts special information based on the syntax of the phrases reconstructed from the character stream.

Once the extraction module 195 has extracted any textual information from a graphic image, that textual information is stored in the notes database 150 in the same record from which the graphic image was obtained. The extraction module 195 signals a verification module 235 that the textual information extracted from graphic image has been stored in the notes database 150. The signal used to notify the verification module 235 is referred to as the “extracted” signal 230.

Upon receiving the extracted signal 230 from the extraction module 195, the verification module 235 retrieves the textual information together with the graphic image for the given record stored in the notes database 150. The verification module 235 presents the graphic image to the user together with the textual information extracted therefrom. This information is presented to the user in a graphical form at a user terminal 240. In most embodiments, the user terminal 240 comprises the display screen and keyboard of the computer executing the user program.

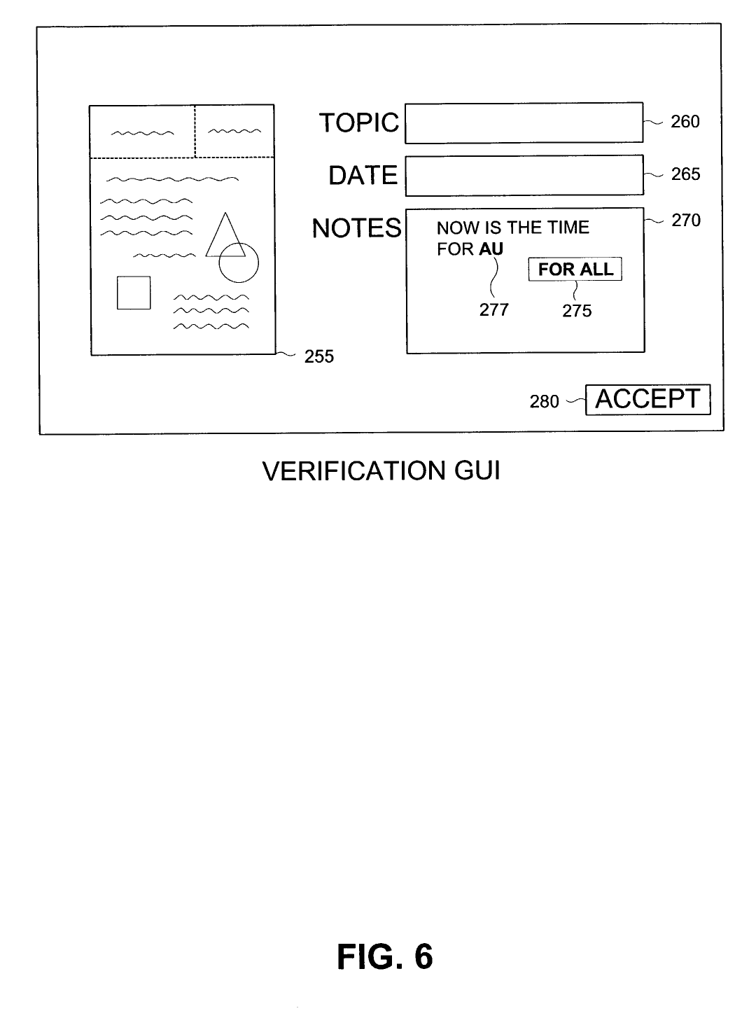

FIG. 6 is a pictorial representation of a graphical user interface used for verification of textual information extracted from a graphic image. In this illustrative example, the verification graphical user interface (GUI) 250 comprises an image display window 255. In some embodiments, the verification GUI 250 may further comprise a topic entry window 260. In yet other embodiments, the verification GUI 250 may further comprise a date entry window 265. And yet in another example embodiment, the verification GUI 250 may further comprise a notes presentation window 270. In the preferred embodiment of the present invention, the verification GUI 250 comprises an “accept” command button 280.

Upon receiving notification that all textual information has been extracted from a graphic image, the verification module 235 retrieves the graphics image and the textual information from the notes database 150. The verification module 235 populates the verification GUI 250 so that meaningful information can be presented to the user. Prior to presenting the verification GUI 250 to the user, the verification module 235 injects the graphics image received from the notes database 150 into the image display window 255. In those implementations of the present invention that extract and store a topic heading for each sheet of notepaper, the textual information that depicts the topic for the image is retrieved from the notes database 150, specifically from the topic field 165 from the record of interest. This textual information is injected into the topic entry window 260.

In those implementations that extract and store a date for each sheet of notepaper acquired from the flatbed scanner 120, the verification module 235 retrieves the date value for the record stored in the date field 160 in the notes database 150. The date value is injected into the date entry window 265. Likewise, any other readable text that is stored in the text field 170 is retrieved from the record and injected into the notes presentation window 270.

Once all of the textual information affiliated with the graphic image and the graphic image itself is injected into the verification GUI 250, the verification module 235 presents the verification GUI 250 to the user. It should be noted at this juncture that prior to injecting any textual information into the verification GUI 250, the verification module 235 highlights any textual information that it suspects was not properly extracted from the graphic image. These suspicions arise through analysis performed by the lexical analyzer 220 in conjunction with the dictionary 225. Considering the example depicted in the figure, the phrase “now is the time for all” was properly extracted from the graphic image except for the last word “all”. The word “all” was extracted into two characters “au”. These suspicious extractions are tracked by “suspicion events”. The suspicion events are stored in the notes database 150. Each suspicion event comprises a cropped bitmap of the source image that resulted in the suspicious extraction.

Upon presentation of the verification GUI 250 to the user, it becomes very evident where textual extraction from the graphic image may have failed because the suspicion events are depicted by highlighting portions of textual information presented to the user.

The verification GUI 250 allows the user to disposition suspicious extractions. Using a cursor 277, the user can point to a suspicious extraction i.e. highlighted text. It should also be noted that the user need not select the highlighted text; it is sufficient to simply run the cursor over the highlighted text. In response, the verification GUI 250 will pop up a graphic source window 275. The graphic source window 275 allows the user to view the source graphic that resulted in the suspicious extraction. The user can then select the highlighted text and correct any extraction errors. This process is supported in the topic display window 260, in the date display window 265 and in the notes display window 270.

When the user is satisfied with the quality of the extracted text, the user can accept the record using the “accept” command button 280. When the verification module 235 recognizes the “accept” command button 280, the graphic image together with the topic, date and notes textual data and any corrections thereto are stored in the notes database 150 in their corresponding data fields. The notes database 150 will continue to carry a record of suspicious extractions so long as the user does not correct the suspicious textual extraction. Where a suspicious extraction has actually resulted in the correct textual data, the user can accept the highlighted text by moving the cursor 277 over the highlighted text and indicating that the textual extraction is acceptable. Such indication can comprises a double mouse click or other suitable indication means.

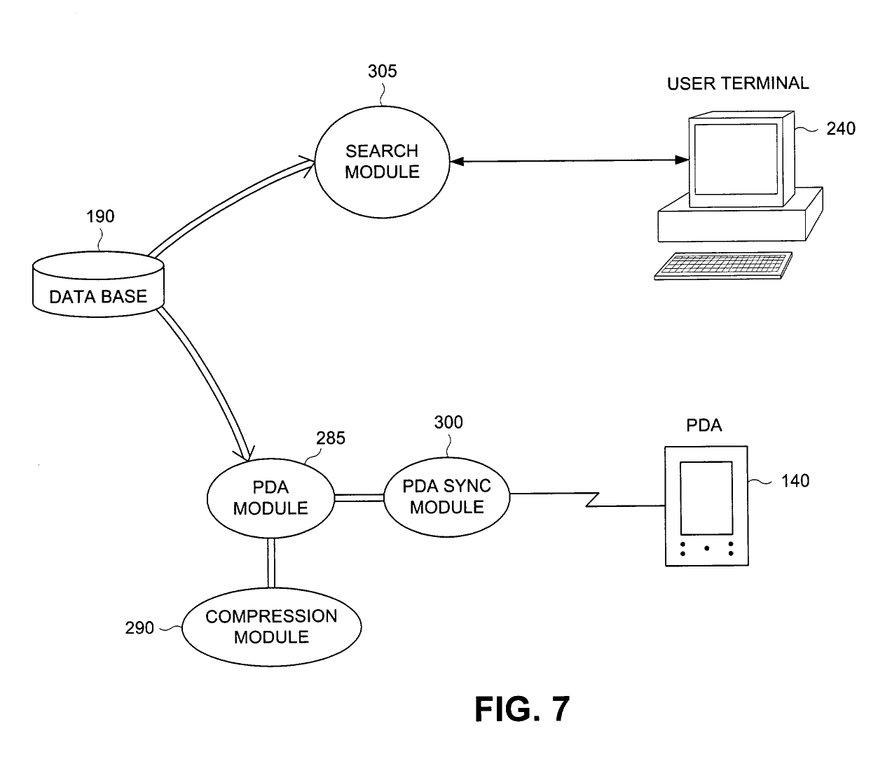

FIG. 7 is a continuation of the flow diagram presented in FIG. 5 and depicts other modules in the user program according to one example embodiment of the present invention. After a user has successfully verified textual extraction from the graphic images of notes taken down on sheets of paper, the user program provides a search module 305 that enables the user to browse notes stored electronically in the notes database 150.

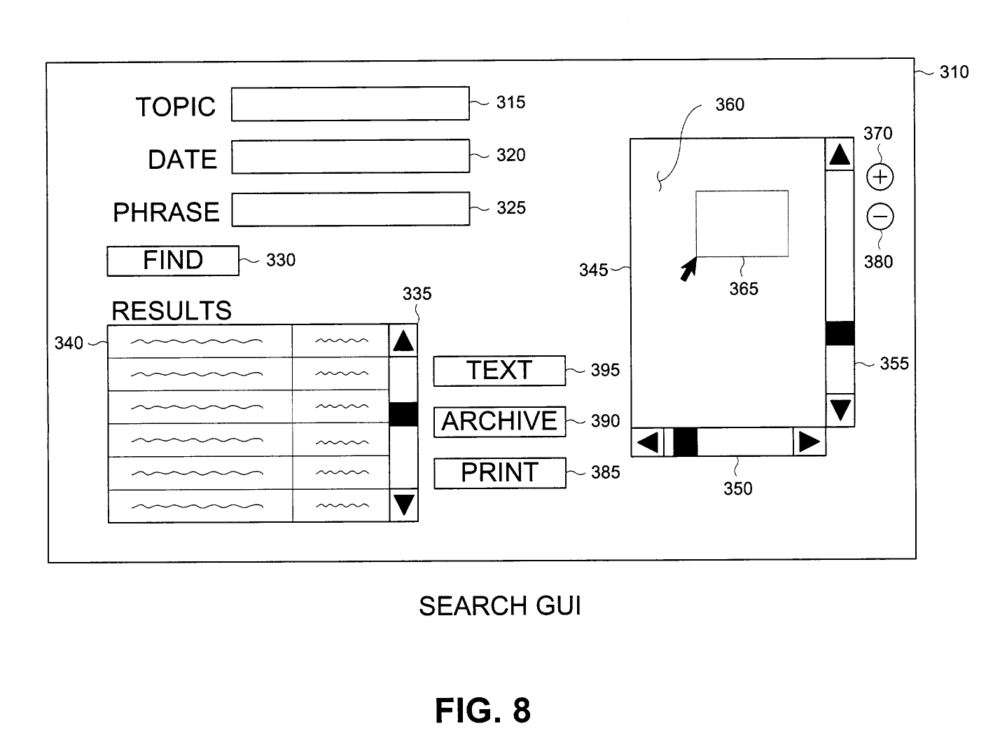

FIG. 8 is a pictorial representation of a search GUI according to one example embodiment of the present invention. The search module 305 presents a search GUI 310 to the user. The search GUI 310 may comprise a topic entry window for a topic heading (topic field 315). The search GUI 310 may further comprise a date entry field 320. The search GUI 310 may also further comprise a phrase entry field 325. The search GUI 310 further comprises a “find” command button 330 together with a results presentation window 340. In operation, the user can enter search criteria into any of the topic field 315, the date field 320 or the phrase field 325 or the user can enter search criteria into any combination of these. When the user is satisfied with the search criteria he has entered, the user can select the “find” command button 330. The search module 305 of one embodiment uses exact matching criteria to select records. In an alternative embodiment of the present invention, the search module 305 employs partial matching and fuzzy selection criteria mechanisms that are well known in the art of database search techniques.

When the search module 305 recognizes that the user has selected the “find” command button 330, the search module 305 uses the search criteria specified by the user and selects one or more records from the notes database 150 that meet the search criteria. The search module 305 then updates the search GUI 310 to include an enumeration of the selected records in the results presentation window 340. The user can use a scroll bar 335 to review any lengthy list of results presented in the results presentation window 340.

The user can select any record enumerated in the results presentation window 340. In response to such a selection, the search module 305 will retrieve the graphic image for the selected record from the notes database 150 and present that image in an image presentation window 345 that further comprises the search GUI 310. The user can then browse the presented image using horizontal and vertical scroll bars (350, 355). The user can also zoom in or out using “zoom-in” and “zoom-out” command buttons (370, 380) that further comprise the search GUI 310. The user can also zoom in using a cursor to define a magnification window 365.

When the user has found the image of the sheets of notepaper that is of current interest, the image can be printed. To accomplish this, the user must select the “print” command button 385 that further comprises the search GUI 310. When the search module 305 recognizes that the user has selected the “print” command button, a print dialog box is presented to the user. The print dialog box comprises those controls customarily provided for printing documents in a windowed environment. Such controls may include, but not necessarily be limited to controls for number of copies, scale factor, print orientation, and selection of a target printer for the print job.

In the event that the user wants to retrieve text code sequences for the textual information extracted from the graphics image, the user must select the “text” command box 395 that further comprises the search GUI 310. In response to the user's indication, the search module 305 will retrieve the textual information from the notes database 150 for the selected record.

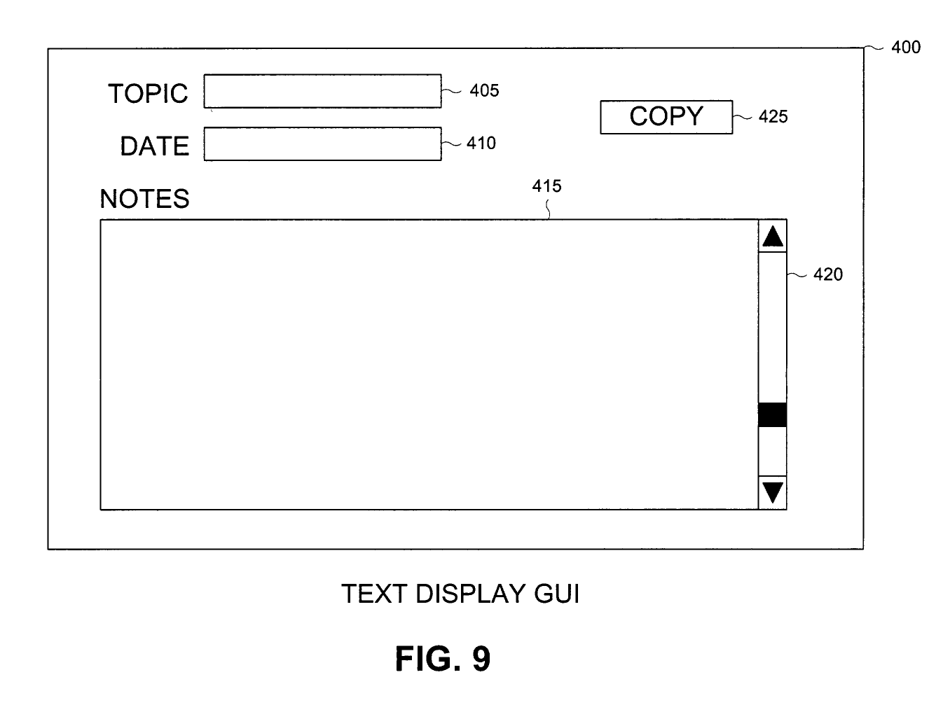

FIG. 9 is a pictorial representation of a text display GUI according to one example embodiment of the present invention. The text display GUI 400 may comprise a topic display 405, a date display 410, and a notes display 415. The search module 305 populates these displays with textual data from the notes database 150. Each of these displays supports the capability of selecting text. Once the user has selected a portion of the text presented in any one of these displays, the user can copy the selected text by indicating this to the search module 305 using a “copy” command button 425 that further comprises the text display GUI 400. In response, the search module 305 will place a copy of the textual information selected by the user into a system clipboard so that other applications, such as word processors and spreadsheets, can have access to that textual information.

FIG. 7 further depicts that the user program may comprise a PDA interface module 285. Upon receiving a command from the user, the user program invokes the PDA interface module 285. The PDA interface module 285 creates a compressed version of the notes database 150 stored on the computer readable media 190. The PDA interface module 285 is augmented by compression module 290 that comprises suitable compression algorithms. Using the search GUI 310, the user can specify which records in the notes database 150 should not be included in the compressed version of the database targeting the PDA. The user must use the “archive” command button 390 that further comprises the search GUI 310. The search module 305 will mark the record as an archive record. Such archive records are not included in the compressed version of the notes database created by the PDA interface module 285. In some alternative embodiments of the present invention, an additional capability to send only the text extracted from graphical images to the PDA is provided. This enables the PDA to receive smaller data sets, but still have access to the textual information recorded in the note taking process.

The PDA interface module 285 conveys the compressed notes database to a PDA synchronization module 300. The PDA synchronization module 300, which is normally provided by the manufacturer of the PDA, conveys the compressed notes database to the PDA 140 upon the next synchronization opportunity. It is important to note that a small PDA search program is also installed on the PDA 140. The PDA search program interacts with the user by presenting search GUIs that collectively form the standard search GUI 310. Because the physical area of the PDA screen is much smaller than a screen provided by a personal computer, the capability of the standard search GUI 310 is partitioned into several smaller GUls used on a PDA. Each of these smaller GUIs collectively comprise the interactive capability of the standard search GUI 310. In one example embodiment, the PDA search program combines search criteria entry fields together with a “find” command button in a first GUI, an enumeration of search results analogous to reference 340 depicted in FIG. 8 in a second GUI, and presentation of a graphics image and textual information in two additional GUIs.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

1. A method for taking electronic notes comprising the steps of:
capturing an image;
storing the image;
extracting textual information from the image;
affiliating the textual information with the image; and
storing the textual information.

2. The method of claim 1 further comprising the steps of:
extracting a topic descriptor from the image; and
storing the topic descriptor.

3. The method of claim 1 further comprising the steps of:
extracting a date descriptor from the image; and
storing the date descriptor.

4. The method of claim 1 further comprising the step of conveying the textual information to a personal digital assistant.

5. The method of claim 1 further comprising the step of conveying the image to a personal digital assistant.

6. The method of claim 1 further comprising the steps of:
receiving search criteria from a user;
finding textual information according to the search criteria; and
presenting the found textual information if textual information
corresponding to the search criteria is found.

7. The method of claim 1 further comprising the steps of:
receiving search criteria from a user;
finding textual information according to the search criteria; and
presenting a graphic image affiliated with the found textual information if
textual information corresponding to the search criteria is found.

8. The method of claim 7 wherein the step of receiving search criteria from a user comprises the step of receiving a topic descriptor or receiving a date descriptor or receiving a phrase.

9. The method of claim 1 wherein the step of extracting textual information from the image comprises the steps of:
recognizing characters in the image; and
providing character codes corresponding to characters recognized in the image.

10. A computer software program comprising:
acquisition module capable of accepting an image from a digitizing source;
extraction module capable of:
extracting textual information from the image;
storing the extracted textual information; and
affiliating the textual information with the image.

11. The computer software program of claim 10 further comprising an optical character recognition module that is called by the extraction module and generates character codes corresponding to printed character discovered in the image.

12. The computer software program of claim 10 further comprising a handwritten character recognition module that is called by the extraction module and generates character codes corresponding to hand-written characters discovered in the image.

13. The computer software program of claim 10 further comprising a printed-text character recognition module that is called by the extraction module and generates character codes corresponding to hand-printed characters discovered in the image.

14. The computer software program of claim 10 further comprising:
plurality of character recognition modules that are called by the extraction
module and generate character codes and positions corresponding to
characters discovered in the image; and
lexical analyzer module that:
receives character codes and positions from the plurality of character recognition modules; and
assembles words or phrases from the character codes according to character codes and positions and an enumeration of known words or phrases.

15. The computer software program of claim 10 wherein the extraction module extracts a topic descriptor or a date descriptor from the image.

16. The computer software program of claim 10 further comprising a search module that:
receives search criteria from a user;
finds textual information according to the search criteria; and
presents the found textual information.

17. The computer software program of claim 10 further comprising a search module that:
receives search criteria from a user;
finds textual information according to the search criteria;
presents an image affiliated with the found textual information.

18. The computer software program of claim 17 wherein the search module receives search criteria in the form of a topic descriptor a date descriptor or a phrase.

19. The computer software program of claim 10 further comprising personal digital assistant module that retrieves textual information and directs said textual information to a synchronization module.

20. The computer software program of claim 10 further comprising personal digital assistant module that retrieves an image affiliated with textual information and directs said image to a synchronization module.
